(19) United States
(12) Patent Application Publication
(10) Pub. No.: US 2017/0250775 A1
(43) Pub. Date: Aug. 31, 2017

(54) OPTICAL MULTIPLEXING DEVICE AND OPTICAL MULTIPLEXING NETWORK SYSTEM

(71) Applicant: FUJITSU LIMITED, Kawasaki-shi (JP)

(72) Inventors: Tomoyuki Kato, Yokohama (JP); Shigeki Watanabe, Kawasaki (JP)

(73) Assignee: FUJITSU LIMITED, Kawasaki-shi (JP)

(21) Appl. No.: 15/362,362

(22) Filed: Nov. 28, 2016

(30) Foreign Application Priority Data
Feb. 25, 2016 (JP) 2016-034917

(51) Int. Cl. H04J 14/06; H04B 10/075; H04J 14/02

(52) U.S. Cl. CPC H04J 14/06; H04J 14/0298; H04B 10/075

(57) ABSTRACT

An optical multiplexing device includes: a control light generator that generates control lights each being a continuous wave light and a subcarrier signal based on an insertion signal having respective optical frequencies, polarized states of the control lights being perpendicular to each other; and at least one nonlinear optical medium that modulates a carrier light based on the control lights.

### CROSS-REFERENCE TO RELATED APPLICATION

This application is based upon and claims the benefit of priority of the prior Japanese Patent Application No. 2016-034917, filed on Feb. 25, 2016, the entire contents of which are incorporated herein by reference.

### FIELD

The embodiments discussed herein are related to an optical multiplexing device and an optical multiplexing network system.

### BACKGROUND

In fiber-optic communications, a number of information signal is transmitted by wavelength-division multiplexing (WDM).

Japanese Laid-open Patent Publication No. 2014-115540 discloses related techniques.

### SUMMARY

According to an aspect of the embodiments, an optical multiplexing device includes: a control light generator that generates control lights each being a continuous wave light and a subcarrier signal based on an insertion signal having respective optical frequencies, polarized states of the control lights being perpendicular to each other; and at least one nonlinear optical medium that modulates a carrier light based on the control lights.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an optical multiplexing device;

FIGS. 2A and 2B illustrate examples of application of a nonlinear optical medium to the optical multiplexing device;

FIGS. 3A and 3B illustrate examples of complementary states of polarization in a case where a nonlinear optical medium is used in the optical multiplexing device;

FIG. 4 illustrates an example of an optical multiplexing device;

FIG. 5 illustrates an example of an optical multiplexing device;

FIG. 6 illustrates an example of an optical multiplexing device;

FIG. 7 illustrates an example of a control light generator of the optical multiplexing device;

FIG. 8 illustrates an example of the control light generator of the optical multiplexing device;

FIG. 9 illustrates an example of the control light generator of the optical multiplexing device; and

FIG. 10 illustrates an example of an optical multiplexing network system including the optical multiplexing device.

### DESCRIPTION OF EMBODIMENTS

In wavelength-division multiplexing (WDM), optical signals with different wavelengths are multiplexed and a plurality of pieces of information are transmitted through a single optical fiber. Such optical signals with different wavelengths are multiplexed (undergo optical multiplexing) by an optical coupler. When a large number of optical signals are multiplexed, however, a large loss is caused in the optical coupler. Thus, low-loss multiplexing is performed using an arrayed waveguide grating and wavelength selective switch, using a micromachine, a liquid crystal element, and a diffraction grating.

In WDM, when a wavelength interval is narrowed so as to increase the number of carrier lights for wide-band information transmission, for example, a fluctuation in the wavelength of each carrier light causes the wavelengths of adjacent optical signals to coincide and the information transmission becomes unstable. Thus, in an optical multiplexing device arranged at a point on a transmission line through which a carrier light is transmitted, subcarrier modulation is sequentially performed at subcarrier frequencies that vary among optical modulators and accordingly, multiplexing at high-density wavelength intervals is performed. A large number of pieces of huge-amount information are stably transmitted by multiplexing in high density by using a nonlinear optical medium having wide-band modulation characteristics for an optical modulator and using a wide-band subcarrier optical signal that utilizes an optical frequency comb constituted of a large number of optical frequency components or the like as a modulation signal.

For example, optical modulation using a nonlinear optical medium has polarization dependence, and variation in modulation efficiency may be caused by change in a polarization state of a carrier light input to the nonlinear optical medium. The variation in the modulation efficiency among polarized states may cause variation in signal quality of a multiplexed optical signal.

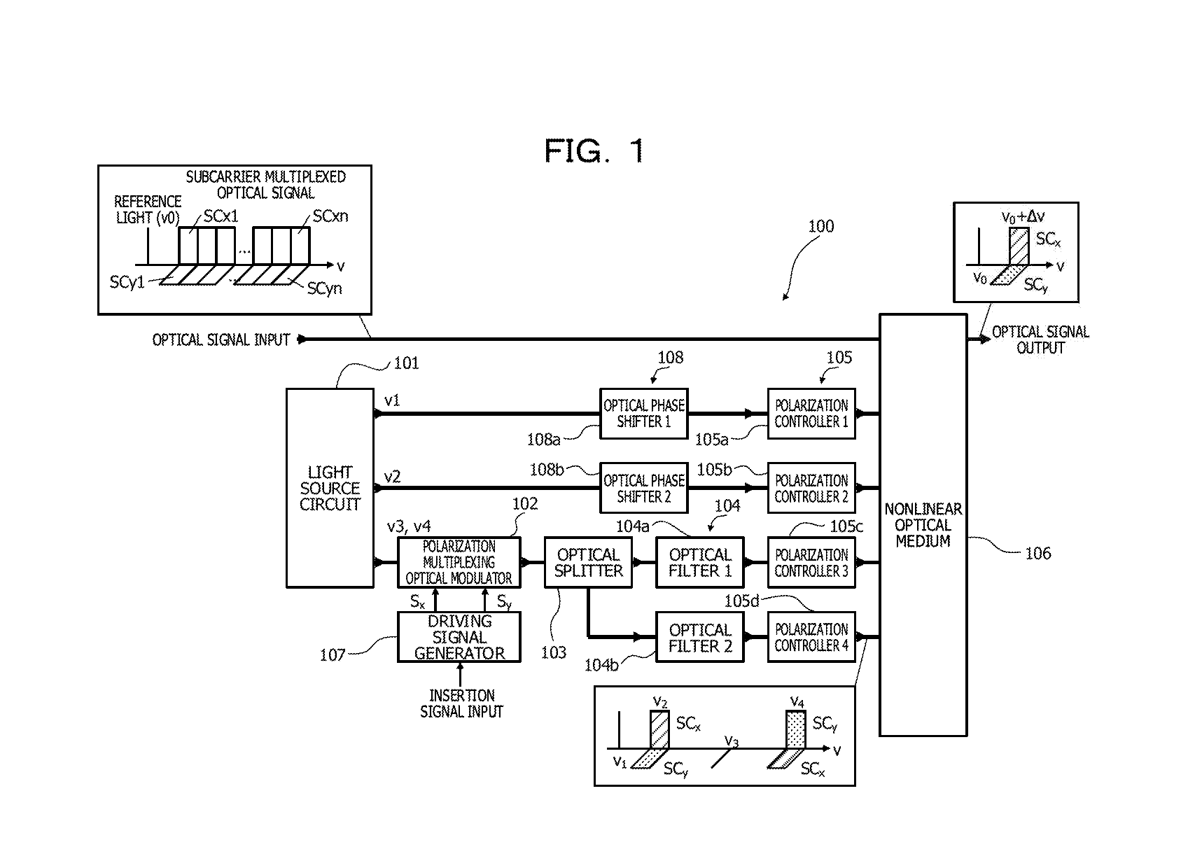

FIG. 1 illustrates an example of an optical multiplexing device.

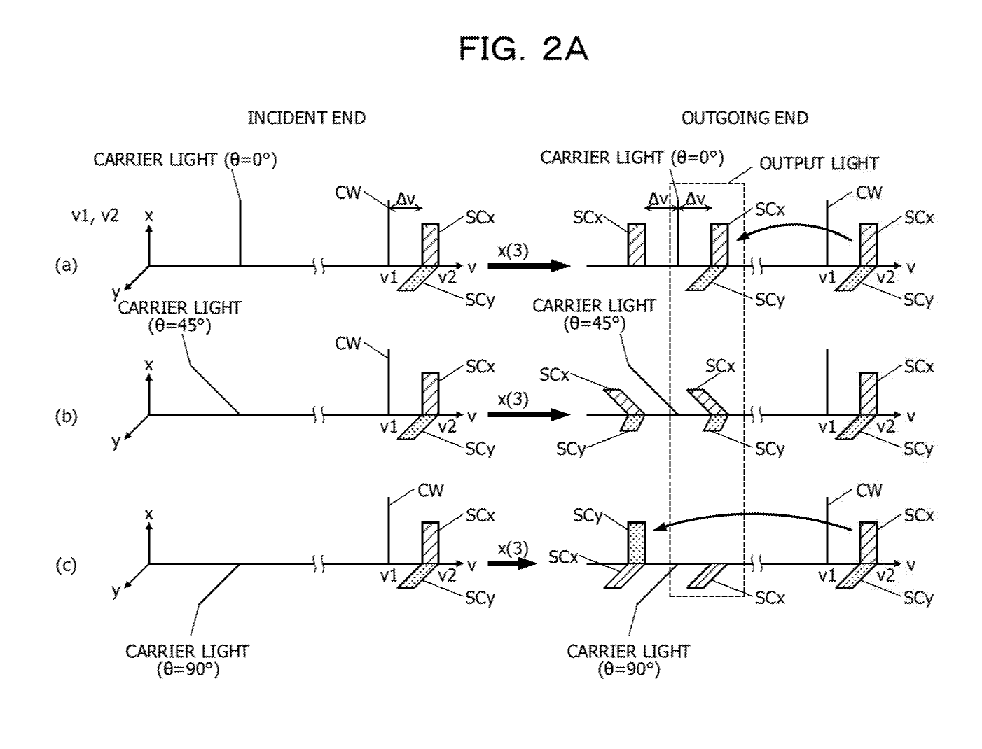

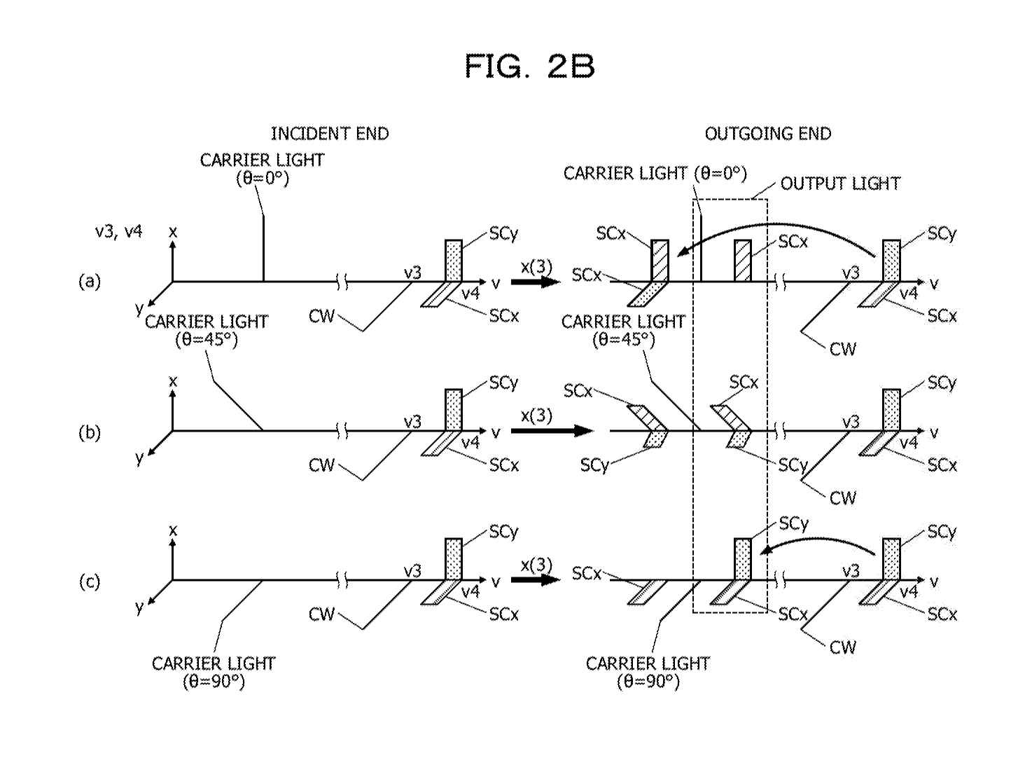

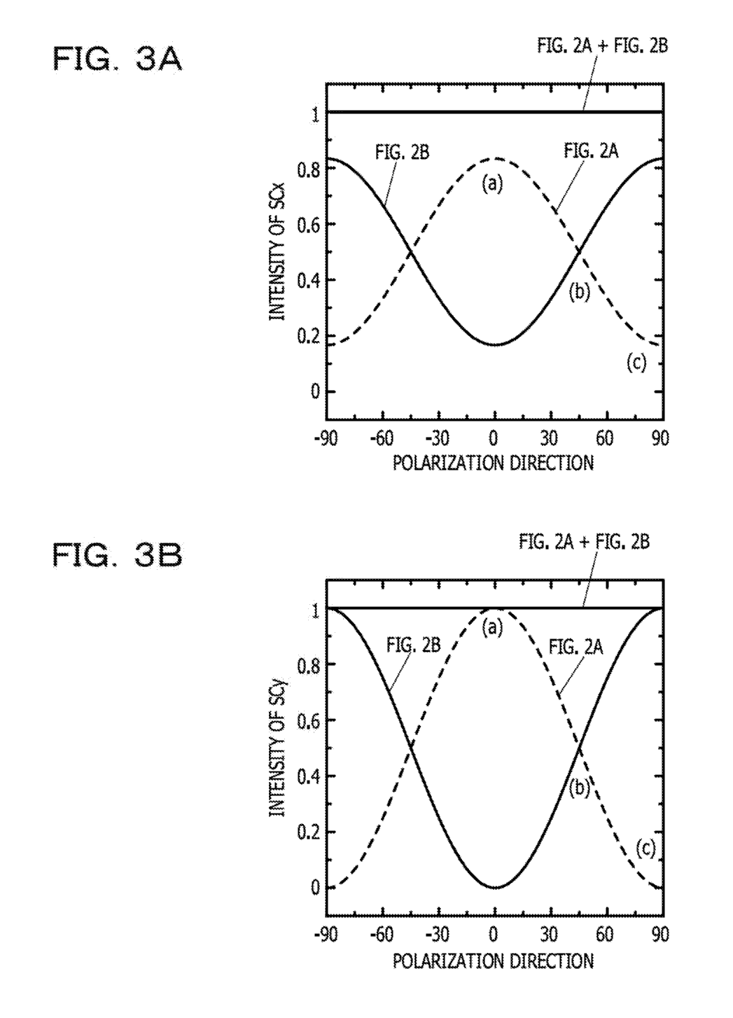

FIGS. 2A and 2B illustrate examples of application of a nonlinear optical medium to the optical multiplexing device. The horizontal axis indicates an optical frequency ν and the vertical axis indicates the intensity (power) of an optical signal.

An optical multiplexing device 100 in FIG. 1 is arranged at a predetermined point on an optical transmission line and has a function of an optical splitting insertion device, which inserts (inputs) or splits (outputs) an optical signal at the point onto the optical transmission line. Hereinafter, ν indicates an optical frequency and f indicates an electric frequency.

The optical multiplexing device 100 illustrated in FIG. 1 includes a light source circuit 101, a polarization multiplexing optical modulator 102, an optical splitter 103, an optical filter 104, a polarization controller 105, a nonlinear optical medium 106, a driving signal generator 107, and an optical phase shifter 108.

A carrier light input to the optical multiplexing device 100 includes a subcarrier multiplexed optical signal and a carrier light. In the subcarrier multiplexed optical signal, optical signals with a plurality of subcarrier frequencies, which are SCx1 to SCxn and SCy1 to SCyn, are multiplexed. The polarization directions of the subcarrier optical signals SCx and SCy are perpendicular to each other. The optical frequency of the carrier light is different from the optical frequency of the subcarrier multiplexed optical signal. Here, ν0 represents a reference optical frequency.

The optical signal input illustrated in FIG. 1 is in a subcarrier multiplexed state of a plurality of optical signals. For convenience sake, optical multiplexing is described below, which is based on an insertion signal input to the optical multiplexing device 100 in a state where the subcarrier multiplexed light is not input to the optical multiplexing device 100 from the transmission line.

The optical frequency of the carrier light may be lower than the optical frequency of the subcarrier multiplexed optical signal or may be higher than the optical frequency of the subcarrier multiplexed optical signal. A difference between the optical frequency of the carrier light and the optical frequency of the subcarrier multiplexed optical signal is not particularly limited. For example, when the difference between the optical frequency of the carrier light and the optical frequency of the subcarrier multiplexed optical signal is too small, it may be difficult to divide the carrier light and the subcarrier multiplexed optical signal.

When the difference between the optical frequency of the carrier light and the optical frequency of the subcarrier multiplexed optical signal is too large, the efficiency of nonlinear effect, such as four-wave mixing or mutual phase modulation, may decrease in the nonlinear optical medium 106. Thus, the difference between the optical frequency of the carrier light and the optical frequency of the subcarrier multiplexed optical signal may be decided by taking these factors into account.

As illustrated in FIGS. 2A and 2B, the power of the carrier light may be larger than the power of each subcarrier optical signal (SCx or SCy). For example, the power of the carrier light may be large enough to cause sufficient nonlinear effect in the nonlinear optical medium 106. The carrier light may be for example, a continuous oscillation light, hereinafter also referred to as a “continuous wave (CW) light”.

The light source circuit 101 of the optical multiplexing device 100 in FIG. 1 may be a comb light source, and generates and outputs CW lights CW (CW1 to CW4) with a plurality of different given (four) optical frequencies. The CW light generated in the optical multiplexing device 100 may be hereinafter referred to as the control light.

The light source circuit 101 generates the CW light CW1 with an optical frequency ν1, the CW light CW2 with an optical frequency ν2, the CW light CW3 with an optical frequency ν3, and the CW light CW4 with an optical frequency ν4.

For example, FIG. 2A illustrates the polarization states of the CW lights CW1 and modulated signals based on CW2 with the respective optical frequencies ν1 and ν2 and FIG. 2B illustrates the polarization states of the CW lights CW3 and modulated signals based on CW4 with the respective optical frequencies ν3 and ν4.

The respective optical frequencies ν1 to ν4 of the CW light CW1, the CW light CW2, the CW light CW3, and the CW light CW4 may each be different (largely separate) from the optical frequency of the carrier light and may also be different from the optical frequency of the subcarrier multiplexed optical signal. A difference between the optical frequency ν1 of the CW light CW1 and the optical frequency ν2 of the CW light CW2 and a difference between the optical frequency ν3 of the CW light CW3 and the optical frequency ν4 of the CW light CW4 are represented as Δν, which is indicated by frequency information.

For example, the difference between the optical frequency ν1 of the CW light CW1 and the optical frequency ν2 of the CW light CW2 (the difference in the optical frequency) may be the same as a difference Δν between the optical frequency of the carrier light and the optical frequency of a subcarrier optical signal SCk that is multiplexed. The difference between the optical frequency ν3 of the CW light CW3 and the optical frequency ν4 of the CW light CW4 may also be the same as the difference Δν between the optical frequency of the carrier light and the optical frequency of the subcarrier optical signal SCk that is multiplexed. The relations are expressed in an equation below.

|ν1−ν2|=|ν3−ν4|=Δν

(including relative phase noise),

where |ν1−ν3|>>Δν.

In the optical frequencies, ν1 and ν2 can be adjacent to each other by a unit grid while ν3 and ν4 can also be adjacent to each other by a unit grid, and a condition on which the optical frequencies (ν1, ν2) and the optical frequencies (ν3, ν4) are separate from each other is set.

An electric insertion signal (a digital signal) input to the optical multiplexing device 100 is input to the driving signal generator 107 and after analog-to-digital (AD) conversion, is input to the polarization multiplexing optical modulator 102 as a driving signal. The polarization multiplexing optical modulator 102 modulates the CW lights CW2 and CW4 with driving signals Sₓ and S_{y} generated by the driving signal generator 107, and generates polarization multiplexed optical signals SC2 and SC4.

Two optical phase shifters 108 may be arranged. The optical phase shifter 1 (108a) and the optical phase shifter 2 (108b) adjust the optical phase of the CW light CW1 and the optical phase of the CW light CW3 so that the phase of Δν coincides and output the resultant CW lights. The polarization multiplexing optical modulator 102 generates polarization multiplexed optical signals SC2 and SC4 by modulating the CW lights CW2 and CW4. The optical splitter 103 splits the polarization multiplexed optical signals SC2 and SC4 output by the polarization multiplexing optical modulator 102 into two. The polarization multiplexed optical signals SC2 and SC4 split into two by the optical splitter 103 are input to the two optical filters 104 (104a and 104b).

The two optical filters, which are the optical filter 1 (104a) and the optical filter 2 (104b), extract only ν2 and ν4, respectively.

Four polarization controllers 105 may be arranged. The polarization controller 1 (105a) and the polarization controller 3 (105c) perform control so that the polarized state of the CW light CW1 and the polarized state of the CW light CW3 are perpendicular to each other. The polarization controller 2 (105b) and the polarization controller 4 (105d) perform control so that the polarized state of the polarization multiplexed optical signal SC2 and the polarized state of the polarization multiplexed optical signal SC4 are perpendicular to each other. An optical signal that the polarization controller 105 outputs may be referred to as a control light.

The carrier light, the CW lights CW1 and CW3 generated by the light source circuit 101, and the polarization multiplexed optical signals SC2 and SC4 after the optical modulation in the polarization multiplexing optical modulator 102 are input to the nonlinear optical medium 106.

The nonlinear optical medium 106 may be implemented using for example, an optical waveguide, such as an optical fiber, a high nonlinear fiber, a high refractive index difference optical waveguide having silicon or the like in the core, or a periodical polarization electric optical crystal. A plurality of optical signals different in the optical frequency ν are incident onto the nonlinear optical medium 106. Accordingly, the nonlinear effect, such as four-wave mixing or mutual phase modulation, occurs in the nonlinear optical medium 106.

For example, the nonlinear effect of the nonlinear optical medium 106 may be utilized to perform optical multiplexing without polarization dependence.

Described with reference to FIGS. 2A and 2B are polarization multiplexed states of the nonlinear optical medium 106 at an incident end, which is illustrated on the left side, and an outgoing end, which is illustrated on the right side, in a case where the carrier light, the polarization multiplexed optical signals, and the CW lights are incident. The horizontal axis indicates the optical frequency and the vertical axes x and y indicate the respective optical intensities in the perpendicular polarization directions. At the outgoing end of the nonlinear optical medium 106, optical signals indicated with the dashed lines in FIGS. 2A and 2B, which are the carrier light and the polarization multiplexed optical signals SCx and SCy, are output as an output light.

As illustrated in FIG. 2A, Δν represents the difference between the optical frequency of the CW light CW and the optical frequency of the polarization multiplexed optical signal. In this case, a polarization component SCx of the polarization multiplexed optical signal, which is parallel to the CW light CW, is generated in double sidebands of the carrier light and a polarization component SCy of the polarization multiplexed optical signal, which is perpendicular to the CW light CW, is generated in a single sideband of the carrier light.

In FIGS. 2A and 2B, (a) illustrates that θ of the carrier light=0°, (b) illustrates that θ of the carrier light=45°, and (c) illustrates that θ of the carrier light=90°. As illustrated in FIGS. 2A and 2B, the modulation efficiency varies, depending on the polarized state of the carrier light.

Between (a) and (c) in FIG. 2A, the optical intensity of SCx is higher in (a). Superposition of (a) and (c) in FIG. 2A is applied to the carrier light in a given polarized state, which is transmitted through the transmission line.

FIGS. 3A and 3B illustrate examples of complementary states of polarization in a case where the nonlinear optical medium is used in the optical multiplexing device. FIG. 3A illustrates the optical intensity of SCx (see the vertical axis) relative to the polarization direction (see the horizontal axis) and FIG. 3B illustrates the optical intensity of SCy (see the vertical axis) relative to the polarization direction (see the horizontal axis).

As illustrated in FIGS. 3A and 3B, the characteristics of the optical intensity in each polarization direction, which are illustrated in (a) to (c) in FIG. 2A and indicated with the dashed lines in FIGS. 3A and 3B, are complementary to the characteristics of the optical intensity in each polarization direction, which are illustrated in (a) to (c) in FIG. 2B and indicated with the solid lines in FIGS. 3A and 3B. For example, regarding SCx in FIG. 3A, when the polarization direction is 0°, the characteristics in FIG. 2A indicate the highest optical intensity and the characteristics in FIG. 2B indicate the lowest optical intensity. Also regarding SCy in FIG. 3B, similar characteristics may be held. For example, the optical intensity of SCy varies in a range from 0 to 1 (maximum) while the optical intensity of SCx varies in a range from 0.2 to 0.8.

In FIGS. 3A and 3B, when the characteristics of FIG. 2A (see the dashed lines) and the characteristics of FIG. 2B (see the solid lines) are added, the optical intensity indicates 1 (maximum) in all the polarization directions, which is a steady value.

The polarized state of each polarization multiplexed optical signal (control light) illustrated in FIGS. 2A and 2B is controlled by the polarization controller 105 and input to the nonlinear optical medium 106. When the nonlinear effect of the nonlinear optical medium 106 is actively utilized, polarization dependence is canceled and optical signals are multiplexed regardless of the polarized state of the carrier light as illustrated in FIGS. 3A and 3B.

In the optical multiplexing device 100, the difference frequency corresponding to the difference between the optical frequency of the carrier light and the optical frequency of a designated subcarrier optical signal is utilized to perform the multiplexing of the subcarrier optical signal. The difference frequency may be sufficiently low, compared with the optical frequency of each subcarrier optical signal. To set the difference frequency with accuracy is easy and even when a subcarrier frequency interval is narrow, the multiplexing of the subcarrier optical signal may be performed with accuracy.

As illustrated with the optical signal output in FIG. 1, multiplexing is performed while SCx and SCy perpendicular to each other at an optical frequency ν0+Δν are maintained at a high signal level. In each optical multiplexing device 100 on the transmission line, a plurality of insertion signals are multiplexed on the carrier light by setting Δν corresponding to each subcarrier optical frequency of a subcarrier multiplexed optical signal included in the input light and the carrier light. The polarized state of an insertion signal is adjusted by adjusting the optical phase shifter 108.

The above-described optical multiplexing device may enable optical signals to be multiplexed efficiently without depending on the polarized state of the carrier light.

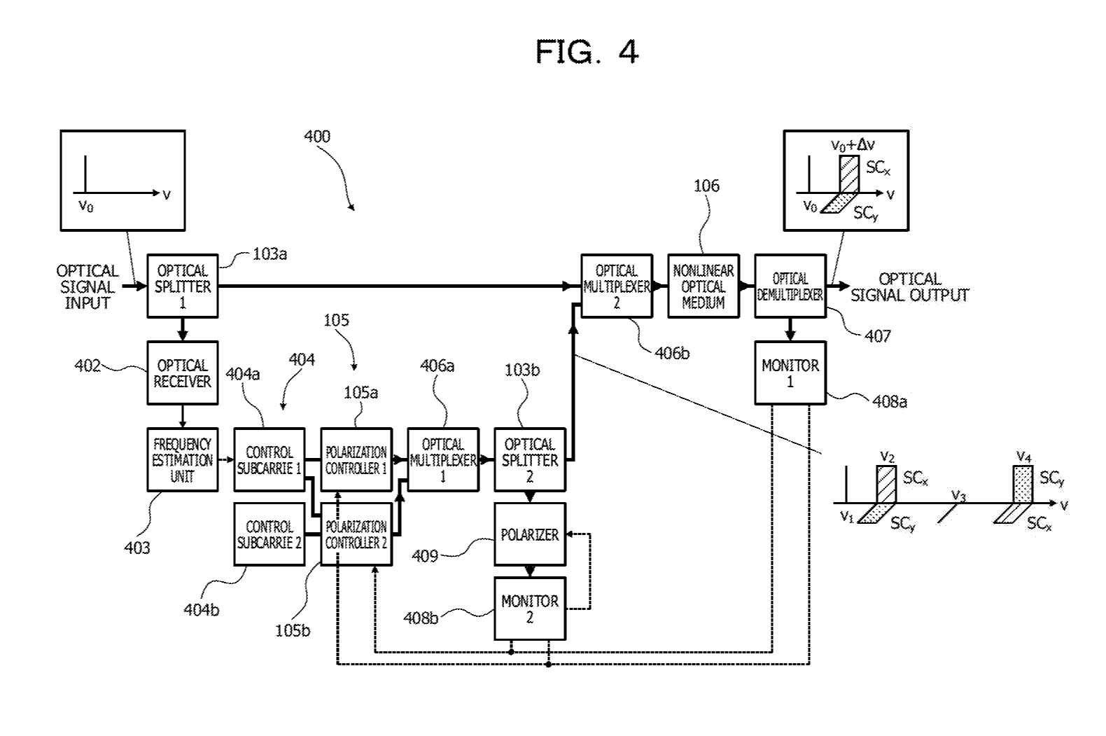

FIG. 4 illustrates an example of an optical multiplexing device. In FIG. 4, the same references may be given to the constituents substantially the same as or similar to those illustrated in FIG. 1 and the descriptions thereof may be omitted. An optical multiplexing device 400 is different from the optical multiplexing device 100 illustrated in FIG. 1 in a configuration related to the generation of a control light. In FIG. 4, the polarization multiplexed states of the optical signals SCx and SCy in each unit are depicted.

For example, the polarized states of a control light 1 of a polarization controller 1 (105a) and a control light 2 of a polarization controller 2 (105b) are controlled so as to be perpendicular to each other.

Apart from the carrier light of CW or the carrier light, an optical splitter 1 (103a) splits a clock light transmitted from the optical multiplexing device 100 at a previous stage on the transmission line and outputs the resultant clock light to a nonlinear optical medium 106 and an optical receiver 402, respectively.

Based on the clock light or the subcarrier optical signal guided from the optical splitter 1 (103a), the optical receiver 402 generates electric signals corresponding to these optical signals. The optical receiver 402 may include a coherent receiver and an AD converter for example. In this case, the coherent receiver generates an electric signal that indicates electric field information on a wavelength-division multiplexed light (I component and Q component).

An instruction to multiplex the polarization multiplexed subcarrier optical signal SCk may be provided to the optical multiplexing device 400. A frequency estimation unit 403 divides the electric signal output by the optical receiver 402 into a clock data recovery (CDR) clock and data, and estimates (or calculates) a difference Δν between the optical frequency of the carrier light and the optical frequency of the subcarrier optical signal SCk. The frequency estimation unit 403 outputs the frequency information indicating the difference Δν to a control subcarrier 404 (404a and 404b), which functions as a control light generator.

The control subcarrier 404 includes functions of the light source circuit 101 and the polarization multiplexing optical modulator 102 illustrated in FIG. 1. A control subcarrier 1 (404a) outputs optical frequencies ν1 and ν2 and a control subcarrier 2 (404b) outputs optical frequencies ν3 and ν4.

The control light 1 output by the control subcarrier 1 (404a) and the control light 2 output by the control subcarrier 2 (404b) are optically multiplexed by an optical multiplexer 1 (406a). An output light of the optical multiplexer 1 (406a) is split by an optical splitter 2 (103b) as the control lights 1 and 2, and one of the split control lights 1 and 2 is output to an optical multiplexer 2 (406b) and the other of the control lights 1 and 2 is output to a polarizer 409.

The optical multiplexer 2 (406b) receives the carrier light input through the optical splitter 1 (103a) and the control light input from the optical splitter 2 (103b), and multiplexes these lights. An output of the optical multiplexer 2 (406b) is input to the nonlinear optical medium 106.

An output of the nonlinear optical medium 106 is demultiplexed in an optical demultiplexer 407, and one is optically output and the other is output to a monitor 1 (408a). The monitor 1 (408a) detects a variation amount of the polarization and performs feedback control on the polarization controllers 1 (105a) and 2 (105b).

The polarization controllers 1 (105a) and 2 (105b) undergo the feedback control through detection of the respective optical intensities of the control lights 1 and 2 using a monitor 2 (408b). With respect to the polarization control for the polarization controllers 1 (105a) and 2 (105b), a feedback control system on the side of the monitor 1 (408a) may be arranged and a feedback control system on the side of the monitor 2 (408b) may be arranged for fine adjustment of polarization deviation (phase deviation).

The frequency estimation unit 403 may include a processor or a circuit that processes a digital signal, such as a central processing unit (CPU) or a digital signal processor (DSP). When the optical receiver includes a coherent receiver, an AD converter, and a fast Fourier transform (FFT) circuit, the FFT circuit may also include a processor or a circuit that processes a digital signal.

Even when the configuration to generate a control light is changed, actions and advantages similar to those of the optical multiplexing device illustrated in FIG. 1 may be obtained by performing control so that the polarized states of the control lights 1 and the control light 2 are perpendicular to each other.

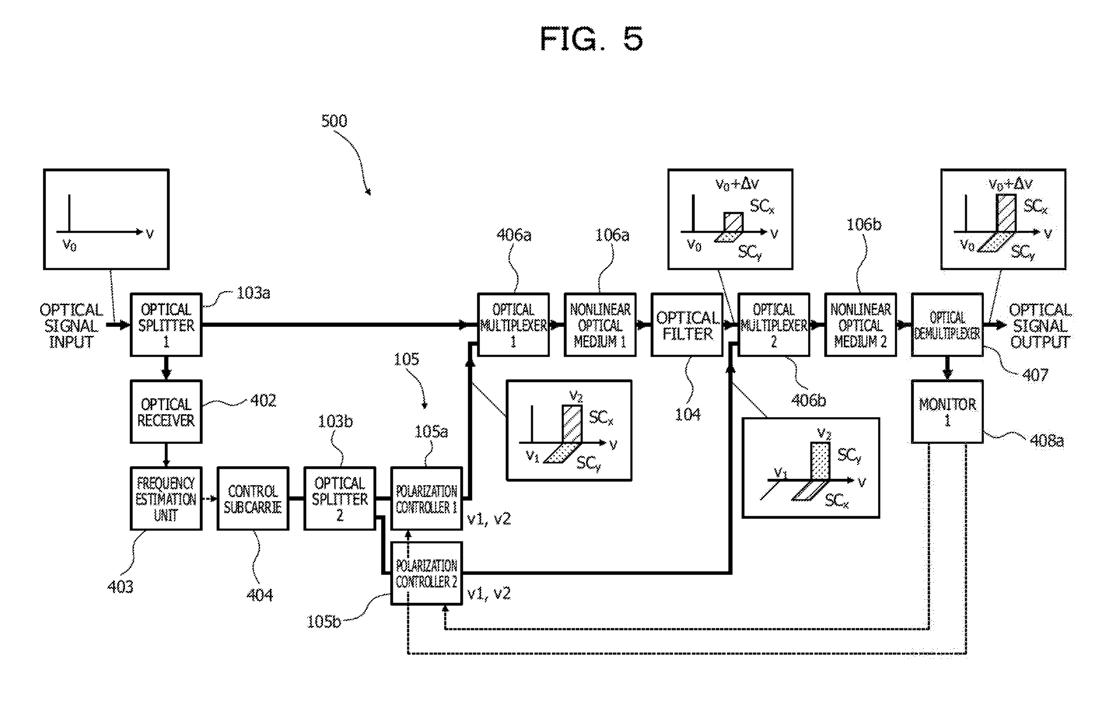

FIG. 5 illustrates an example of an optical multiplexing device 500. In FIG. 5, the same references may be given to the constituents substantially the same as or similar to those illustrated in FIG. 1 or 4 and the descriptions thereof may be omitted. In FIGS. 1 and 4, optical multiplexing with no polarization dependence is performed using the single nonlinear optical medium 106. In the optical multiplexing device 500 illustrated in FIG. 5, optical multiplexing with no polarization dependence may be performed using two nonlinear optical media, which are the nonlinear optical medium 1 (106a) and the nonlinear optical medium 2 (106b).

The control subcarrier 404 outputs only two optical frequencies ν1 and ν2, which are split by the optical splitter 2 (103b) to be output to the polarization controller 1 (105a) and the polarization controller 2 (105b).

The control light 1 of the optical frequencies ν1 and ν2 output from the polarization controller 1 (105a) is multiplexed by the optical multiplexer 1 (406a) with the carrier light, and is input to the nonlinear optical medium 1 (106a). An output light of the nonlinear optical medium 1 (106a) is output to the optical multiplexer 2 (406b) after the optical filter 104 deletes the optical frequencies ν1 and ν2 to leave the carrier light and the signal only.

The control light 2 of the optical frequencies ν1 and ν2 output from the polarization controller 2 (105b) is multiplexed by the optical multiplexer 2 (406b) with the carrier light output from the nonlinear optical medium 1 (106a), and is input to the nonlinear optical medium 2 (106b). The polarization controller 1 (105a) and the polarization controller 2 (105b) perform control so that the polarized states of the control light 1 and the control light 2 are perpendicular to each other.

Actions and advantages similar to those of the optical multiplexing device illustrated in FIG. 1 or 4 may also be obtained by using the two nonlinear optical media 1 (106a) and 2 (106b). For example, the optical multiplexing device illustrated in FIG. 5 may be configured using a single modulator (the control subcarrier 404) that outputs the optical frequencies ν1 and ν2 of adjacent grids.

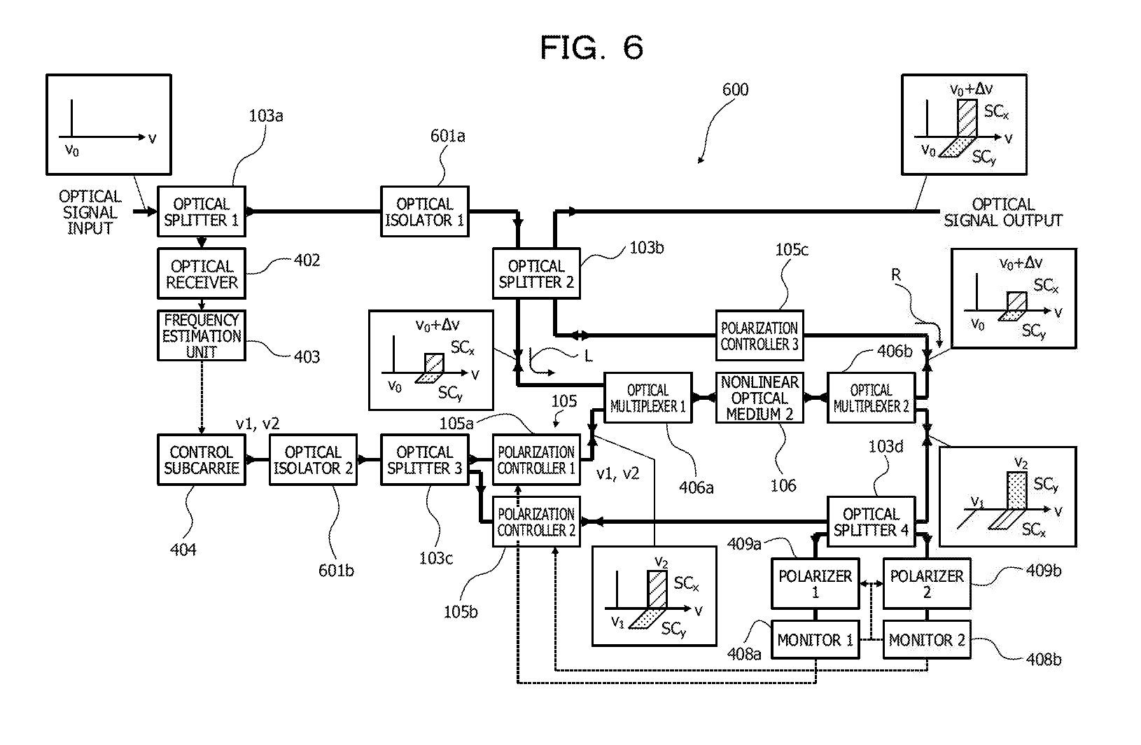

FIG. 6 illustrates an example of an optical multiplexing device. In FIG. 6, the same references may be given to the constituents substantially the same as or similar to those illustrated in FIG. 1, 4, or 5 and the descriptions thereof may be omitted. In an optical multiplexing device 600, optical multiplexing with no polarization dependence may be performed using a single optical modulator (a control subcarrier 404) and the single nonlinear optical medium 106.

In the optical multiplexing device 600, optical multiplexing with no polarization dependence is performed by inputting control lights from both sides of a single nonlinear optical medium 106.

While the nonlinear optical medium 106 is centrally positioned, an optical multiplexer 1 (406a), an optical multiplexer 2 (406b), and a polarization controller 3 (105c) are arranged between the nonlinear optical medium 106 and an optical splitter 2 (103b), and a clockwise optical signal path, which is indicated as R in FIG. 6, and a counterclockwise path, which is indicated as L in FIG. 6, are formed. An optical isolator 1 (601a) is arranged between an optical splitter 1 (103a) and an optical splitter 2 (103b) and inhibits traveling of the carrier light in an opposite direction. An optical isolator 2 (601b) is arranged between the control subcarrier 404 and the optical splitter 3 (103c) as well.

The optical splitter 2 (103b) splits the carrier light and the carrier light is guided to both ends of the nonlinear optical medium 106 through the clockwise path R and the counterclockwise path L. The optical splitter 2 (103b) multiplexes the carrier lights of the clockwise path R and the counterclockwise path L, which are output from both ends of the nonlinear optical medium 106.

The control subcarrier 404 outputs the control lights with optical frequencies ν1 and ν2 and an optical splitter 3 (103c) splits the control lights into two, and the split control lights are input to the polarization controller 1 (105a) and the polarization controller 2 (105b). The control light 1 output by the polarization controller 1 (105a) is output to the optical multiplexer 1 (406a). The control light 2 output by the polarization controller 2 (105b) is output to the optical multiplexer 2 (406b).

The control light 1 is multiplexed with the carrier light by the optical multiplexer 1 (406a) and is input to the nonlinear optical medium 106. The control light 2 is input by the optical multiplexer 2 (406b) to the nonlinear optical medium 106 (from a port) on the side opposite the optical multiplexer 1 (406a).

A monitor 1 (408a) and a monitor 2 (408b) are coupled to both ends of an optical splitter 4 (103d) via polarizers 409a and 409b, respectively, and perpendicular polarized states are detected. Based on feedback outputs of the monitor 1 (408a) and the monitor 2 (408b), the polarization controller 1 (105a) and the polarization controller 2 (105b) perform polarization control so that the polarized states of the control light 1 and the control light 2 are perpendicular to each other.

A signal generated by multiplexing the control lights 1 and 2, which are output from both ends of the nonlinear optical medium 106, and the carrier light is output through the optical splitter 2 (103b) as an optical signal.

In the optical multiplexing device 600 illustrated in FIG. 6, optical multiplexing is performed by using the single nonlinear optical medium 106 and a single optical modulator (the control subcarrier 404) and causing optical signals to be input and output to the nonlinear optical medium 106 in a loop. Actions and advantages similar to the advantages illustrated in FIG. 1, 4, or 5 may be obtained.

For example, the control light generator may correspond to the internal configuration of the control subcarrier 404 illustrated in FIG. 1, 4, 5, or 6.

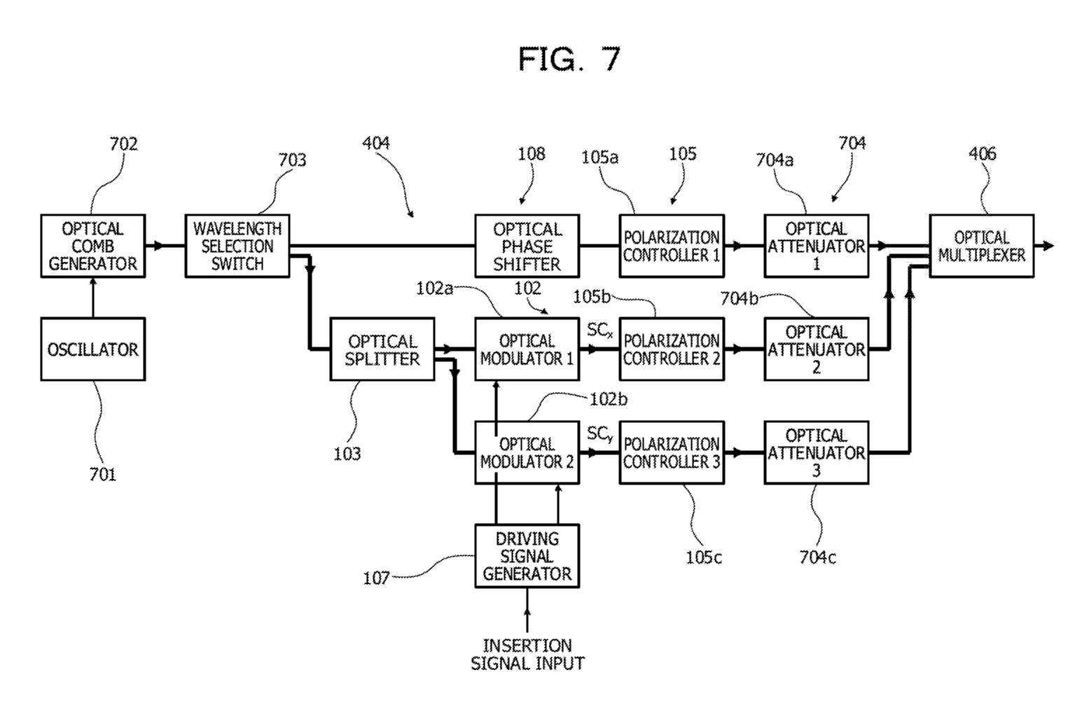

FIG. 7 illustrates an example of the control light generator of the optical multiplexing device. In FIG. 7, the same references may be given to the constituents substantially the same as or similar to those illustrated in FIG. 1 and the descriptions thereof may be omitted. The control light generator (the control subcarrier 404) illustrated in FIG. 7 may be applied as the control light generator illustrated in FIG. 1 or 4.

The control subcarrier 404 multiplexes polarization multiplexed optical signals having an optical frequency ν different from that of a CW light and outputs the resultant signal. An oscillator 701 outputs a sine wave f0 with the subcarrier frequency or with a frequency that is one Nth of the subcarrier frequency, where N represents an integer, so as to decide the subcarrier frequency of a subcarrier signal multiplexed in the optical multiplexing device.

An optical comb generator (an optical frequency comb) 702 outputs an optical frequency comb at frequency intervals of f0, which is based on the sine wave f0 output by the oscillator 701. A wavelength selection switch 703 extracts two CW lights νS and νS+Δν at a desired frequency interval from the optical comb generator 702 and outputs the extracted CW lights to the polarization controller 1 (105a) and the optical splitter 103.

The optical phase shifter 108 controls the optical phase of the CW light νS output by the wavelength selection switch 703 and outputs the CW light νS to the polarization controller 1 (105a). The polarization controller 1 (105a) controls the polarized state of the CW light νS output by the wavelength selection switch 703 and outputs the CW light νS to an optical attenuator 1 (704a). The optical attenuator 1 (704a) controls the optical intensity of the CW light νS output by the polarization controller 1 (105a) and outputs the CW light νS to the optical multiplexer 406.

The optical splitter 103 splits the CW light νS+Δν and outputs the split CW light νS+Δν to the optical modulator 1 (102a) and the optical modulator 2 (102b).

The optical modulator 1 (102a) performs optical modulation on the CW light νS+Δν output by the optical splitter 103 in accordance with the driving signal generated by the driving signal generator 107 based on an insertion signal, and outputs the resultant CW light νS+Δν to the polarization controller 2 (105b).

The polarization controller 2 (105b) controls the polarized state of a modulation light 1 output by the optical modulator 1 (102a) and outputs the modulation light 1 to an optical attenuator 2 (704b). The optical attenuator 2 (704b) controls the optical intensity of the modulation light 1 output by the polarization controller 2 (105b) and outputs the modulation light 1 to the optical multiplexer 406.

The optical modulator 2 (102b) performs optical modulation on the CW light νS+Δν output by the optical splitter 103 in accordance with the driving signal generated by the driving signal generator 107 based on the insertion signal, and outputs the resultant CW light νS+Δν to the polarization controller 3 (105c).

The polarization controller 3 (105c) controls the polarized state of a modulation light 2 output by the optical modulator 2 (102b) and outputs the modulation light 2 to an optical attenuator 3 (704c). The optical attenuator 3 (704c) controls the optical intensity of the modulation light 2 output by the polarization controller 3 (105c) and outputs the modulation light 2 to the optical multiplexer 406.

With reference to FIG. 7, for example, application to the optical multiplexing device 500 illustrated in FIG. 1 or FIG. 4 is described. In this case, the wavelength selection switch 703 extracts four CW lights, which are νS1, νS1+Δν, νS2, and νS2+Δν, at desired frequency intervals from the optical comb generator 702 and outputs νS1 and νS2 to the polarization controller 1 (105a). Then νS1+Δν and νS2+Δν are output to the optical splitter 103. The above-described control light generator (the control subcarrier 404) extracts a desired optical frequency using the wavelength selection switch 703.

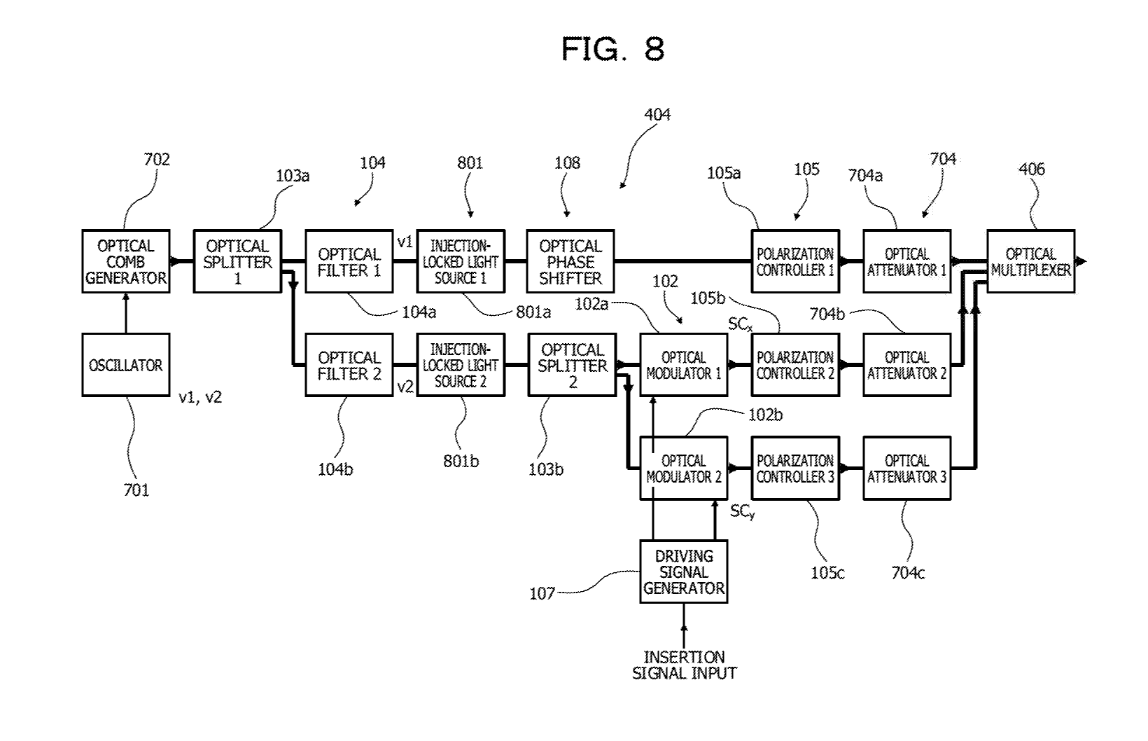

FIG. 8 illustrates an example of the control light generator of the optical multiplexing device. In FIG. 8, the same references may be given to the constituents substantially the same as or similar to those illustrated in FIG. 7 or the like and the descriptions thereof may be omitted. The control light generator (the control subcarrier 404) illustrated in FIG. 8 may be applied as the control light generator illustrated in FIG. 5 or 6.

As illustrated in FIG. 8, an optical component is extracted by arranging the optical filter 104 and an injection-locked light source 801. A CW light of the optical comb generator 702, which includes the optical frequencies ν1 and ν2 for example, is split into two by the optical splitter 1 (103a) and then undergo band extraction (ν1, ν2) at the two optical filters 104a and 104b, respectively. After that, the CW lights of the optical frequencies ν1 and ν2 may be input to the injection-locked light sources 1 (801a) and 2 (801b) and optical injection may stabilize control lights.

The functions from the optical splitter 103a to the injection-locked light source 801 illustrated in FIG. 8 may be the same as the function of the wavelength selection switch 703 in FIG. 7.

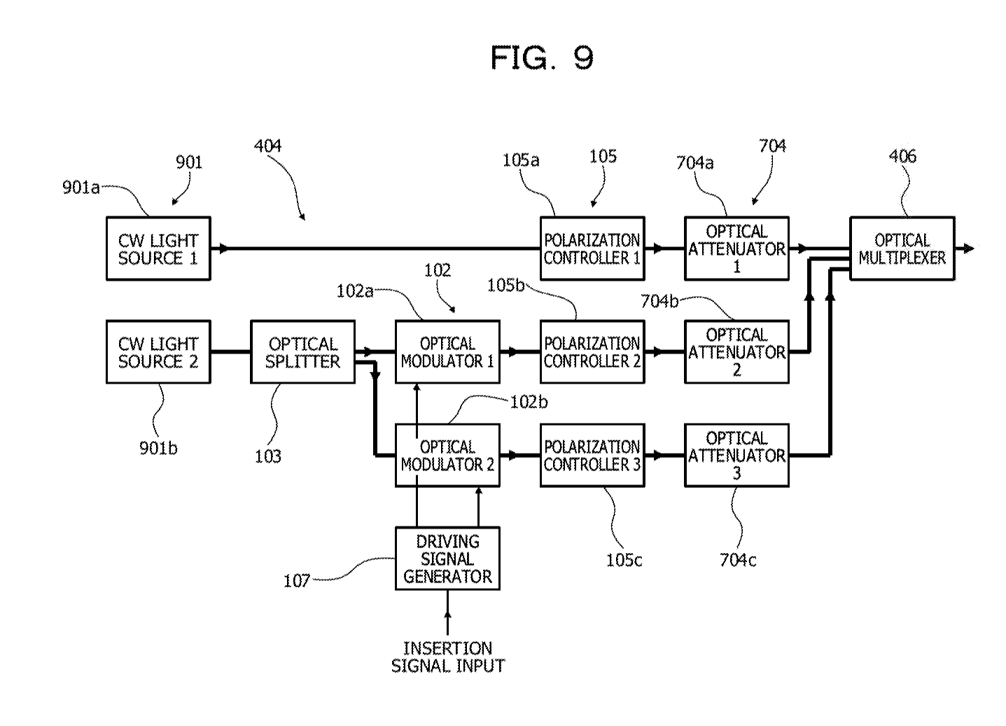

FIG. 9 illustrates an example of the control light generator in the optical multiplexing device. In FIG. 9, the same references may be given to the constituents substantially the same as or similar to those illustrated in FIG. 7 or the like and the descriptions thereof may be omitted. The control light generator (the control subcarrier 404) illustrated in FIG. 9 may be applied as the control light generator illustrated in FIG. 5 or 6.

In the control light generator 404 illustrated in FIG. 7 or 8, a control light is generated using the optical comb generator 702. In the control light generator 404 illustrated in FIG. 9, a control light is generated using two CW light sources 901a and 901b. The subcarrier frequency is decided with optical frequency accuracies of the two CW light sources 901a and 901b. Thus, although the accuracy of the subcarrier frequency may be slightly lower than that in the optical comb generator 702 illustrated in FIG. 7 or 8, the configuration of a light source may be simplified.

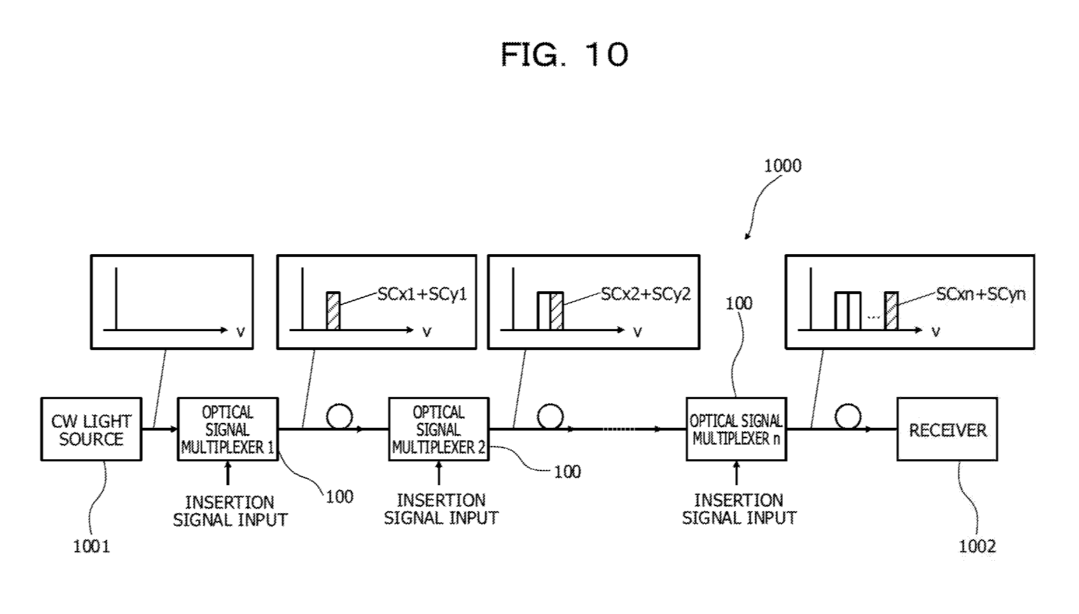

FIG. 10 illustrates an example of an optical multiplexing network system including the optical multiplexing device. On a transmission line 1000, a CW light source 1001 of a carrier light is arranged at one end, and for example, a receiver 1002 is arranged at the other end.

A plurality of optical multiplexing devices 100 (optical signal multiplexers 1 to n) are arranged at given points on the transmission line 1000. The optical multiplexing devices 100 perform subcarrier modulation sequentially on an input electric insertion signal using subcarrier optical signals SCx1 to SCxn with different subcarrier frequencies and subcarrier optical signals SCy1 to SCyn perpendicular to SCx1 to SCxn.

Thus, optical signal multiplexing may be performed at high-density wavelength intervals on the optical multiplexing network system. For example, a large number of pieces of huge-amount information may be stably transmitted by multiplexing in high density by using a nonlinear optical medium having wide-band modulation characteristics for an optical modulator and using a wide-band subcarrier optical signal that utilizes an optical frequency comb as a modulation signal.

Control that causes the polarized states of a plurality of control lights in the optical multiplexing device to be perpendicular to each other regardless of variation in the polarized state, such as polarization rotation of a carrier light, is performed. Thus, in mutual phase modulation between control lights in a nonlinear optical medium, complementary polarized states are formed. The modulation efficiency may be maximized.

In a configuration where a nonlinear optical medium is used for optical multiplexing, regardless of the polarization dependence of the optical modulation, which the nonlinear optical medium has, no variation may be caused in the modulation efficiency even when the polarized state of the carrier light input to the nonlinear optical medium changes. The signal quality of an optical signal on a transmission line, which is obtained by multiplexing, may increase.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical multiplexing device comprising:
a control light generator that generates control lights each being a continuous wave light and a subcarrier signal based on an insertion signal having respective optical frequencies, polarized states of the control lights being perpendicular to each other; and
at least one nonlinear optical medium that modulates a carrier light based on the control lights.

2. The optical multiplexing device according to claim 1, wherein
the control light generator, when four optical frequencies different from optical frequencies of the carrier light and a subcarrier multiplexed optical signal included in the carrier light are represented as a first optical frequency ν1, a second optical frequency ν2, a third optical frequency ν3, and a fourth optical frequency ν4, sets a difference Δν in such a manner a first frequency difference between the first optical frequency ν1 and the second optical frequency ν2, a second frequency difference between the third optical frequency ν3 and the fourth optical frequency ν4, and a difference between the optical frequency of the carrier light and an optical frequency of the subcarrier optical signal included in the subcarrier multiplexed optical signal becomes substantially equal.

3. The optical multiplexing device according to claim 2, wherein
a following equation establishes:

|ν1−ν2|=|ν3−ν4|=Δν,
where |ν1−ν3|>>Δν while polarized states of ν3 and ν4 are perpendicular to polarized states of ν1 and ν2.

4. The optical multiplexing device according to claim 1, wherein
the control light generator generates and outputs a first control light and a second control light that are in polarized states perpendicular to each other, and
the optical multiplexing device further includes:
an optical multiplexer that multiplexes the carrier light, the first control light, and the second control light and outputs a resultant light to the nonlinear optical medium.

5. The optical multiplexing device according to claim 1, wherein
the control light generator generates and outputs a first control light and a second control light that are in polarized states perpendicular to each other, and
the optical multiplexing device further includes:
a first optical multiplexer that multiplexes the carrier light and the first control light;
a first nonlinear optical medium, included in the at least one nonlinear optical medium, that modulates the carrier light based on the first control light;
a second optical multiplexer that multiplexes the carrier light and the second control light; and
a second nonlinear optical medium, included in the at least one nonlinear optical medium, that modulates the carrier light based on the second control light.

6. The optical multiplexing device according to claim 1, wherein
the control light generator generates and outputs a first control light and a second control light that are in polarized states perpendicular to each other, and
the carrier light and the first and second control lights are input to respective both ends of the at least one nonlinear optical medium.

7. The optical multiplexing device according to claim 1, comprising:
a polarization controller that monitors a polarized state of an optical signal output by the at least one nonlinear optical medium and performs polarization control in such a manner that polarized states of a first control light and a second control light included in the control lights are perpendicular to each other.

8. The optical multiplexing device according to claim 4, wherein
the control light generator includes:
an optical comb generator that outputs a plurality of lights with optical frequencies different from each other;
a wavelength selection switch that performs wavelength selection on the plurality of lights and outputs a selected light;
an optical splitter that splits the selected light output by the wavelength selection switch; and
an optical modulator that performs optical modulation based on the insertion signal on the light split by the optical splitter and outputs the control light to be output to the nonlinear optical medium.

9. The optical multiplexing device according to claim 4, wherein
the control light generator includes:
an optical comb generator that outputs a plurality of lights with optical frequencies different from each other;
a first optical splitter that splits the plurality of lights;
a pair of polarization controllers that cause polarized states of the lights split by the first optical splitter to be perpendicular to each other;
a pair of injection-locked light sources that stabilize each of lights from the pair of optical filters;
a second optical splitter that splits one of lights from the pair of injection-locked light sources; and
an optical modulator that performs optical modulation based on the insertion signal on the light split by the second optical splitter and outputs the control light to be output to the nonlinear optical medium.

10. The optical multiplexing device according to claim 4, wherein
the control light generator includes:
a continuous wave light source that outputs a plurality of continuous wave lights with optical frequencies different from each other;
an optical splitter that splits the plurality of CW lights;
a pair of polarization controllers that cause polarized states of the lights split by the optical splitter to be perpendicular to each other; and
an optical modulator that performs optical modulation based on the insertion signal on the light split by the optical splitter and outputs the control light to be output to the nonlinear optical medium.

11. An optical multiplexing network system comprising:
an optical transmission line; and
a plurality of optical multiplexing devices arranged on the optical transmission line,
the optical multiplexing devices each includes:
a control light generator that generates a continuous wave light and control lights each being a continuous wave light and a subcarrier signal based on an insertion signal having respective optical frequencies, polarized states of the control lights being perpendicular to each other, and
at least one nonlinear optical medium that modulates a carrier light based on the control lights.

12. The optical multiplexing network system according to claim 11, wherein
the control light generator, when four optical frequencies different from optical frequencies of the carrier light and a subcarrier multiplexed optical signal included in the carrier light are represented as a first optical frequency ν1, a second optical frequency ν2, a third optical frequency ν3, and a fourth optical frequency ν4, sets a difference Δν in such a manner a first frequency difference between the first optical frequency ν1 and the second optical frequency ν2, a second frequency difference between the third optical frequency ν3 and the fourth optical frequency ν4, and a difference between the optical frequency of the carrier light and an optical frequency of the subcarrier optical signal included in the subcarrier multiplexed optical signal becomes substantially equal.

13. The optical multiplexing network system according to claim 12, wherein
a following equation establishes:

|ν1−ν2|=|ν3−ν4|=Δν,
where |ν1−ν3|>>Δν while polarized states of ν3 and ν4 are perpendicular to polarized states of ν1 and ν2.

14. The optical multiplexing network system according to claim 11, wherein
the control light generator generates and outputs a first control light and a second control light that are in polarized states perpendicular to each other, and
the optical multiplexing device further includes:
an optical multiplexer that multiplexes the carrier light, the first control light, and the second control light and outputs a resultant light to the nonlinear optical medium.

15. The optical multiplexing network system according to claim 11, wherein
the control light generator generates and outputs a first control light and a second control light that are in polarized states perpendicular to each other, and
the optical multiplexing device further includes:
a first optical multiplexer that multiplexes the carrier light and the first control light;
a first nonlinear optical medium, included in the at least one nonlinear optical medium, that modulates the carrier light based on the first control light;
a second optical multiplexer that multiplexes the carrier light and the second control light; and
a second nonlinear optical medium, included in the at least one nonlinear optical medium, that modulates the carrier light based on the second control light.

16. The optical multiplexing network system according to claim 11, wherein
the control light generator generates and outputs a first control light and a second control light that are in polarized states perpendicular to each other, and
the carrier light and the first and second control lights are input to respective both ends of the at least one nonlinear optical medium.

17. The optical multiplexing network system according to claim 11, comprising:
a polarization controller that monitors a polarized state of an optical signal output by the at least one nonlinear optical medium and performs polarization control in such a manner that polarized states of a first control light and a second control light included in the control lights are perpendicular to each other.

18. The optical multiplexing network system according to claim 14, wherein
the control light generator includes:
an optical comb generator that outputs a plurality of lights with optical frequencies different from each other;
a wavelength selection switch that performs wavelength selection on the plurality of lights and outputs a selected light;
an optical splitter that splits the selected light output by the wavelength selection switch; and
an optical modulator that performs optical modulation based on the insertion signal on the light split by the optical splitter and outputs the control light to be output to the nonlinear optical medium.

19. The optical multiplexing network system according to claim 14, wherein
the control light generator includes:
an optical comb generator that outputs a plurality of lights with optical frequencies different from each other;
a first optical splitter that splits the plurality of lights;
a pair of polarization controllers that cause polarized states of the lights split by the first optical splitter to be perpendicular to each other;
a pair of injection-locked light sources that stabilize each of lights from the pair of optical filters;
a second optical splitter that splits one of lights from the pair of injection-locked light sources; and
an optical modulator that performs optical modulation based on the insertion signal on the light split by the second optical splitter and outputs the control light to be output to the nonlinear optical medium.

20. The optical multiplexing network system according to claim 14, wherein
the control light generator includes:
a continuous wave light source that outputs a plurality of continuous wave lights with optical frequencies different from each other;
an optical splitter that splits the plurality of CW lights;
a pair of polarization controllers that cause polarized states of the lights split by the optical splitter to be perpendicular to each other; and
an optical modulator that performs optical modulation based on the insertion signal on the light split by the optical splitter and outputs the control light to be output to the nonlinear optical medium.
